(19) United States
(12) Patent Application Publication
(10) Pub. No.: US 2025/0363618 A1
(43) Pub. Date: Nov. 27, 2025

(54) IMAGE PROCESSING APPARATUS

(71) Applicant: Konica Minolta, Inc., Tokyo (JP)

(72) Inventor: Kazuhiro ISHIGURO, Aichi (JP)

(21) Appl. No.: 19/199,496

(22) Filed: May 6, 2025

(30) Foreign Application Priority Data
May 22, 2024 (JP) 2024-083451

(51) Int. Cl. G06T 7/00

(52) U.S. Cl. CPC G06T 7/0008; G06T 2207/30144; G06T 2207/30168

(57) ABSTRACT

To provide an image processing apparatus capable of sufficiently reproducing an image satisfying a user without taking time and labor for adjustment work of image quality reproduction. An image processing apparatus that adjusts image quality of an image formed by an image forming apparatus, the image processing apparatus includes: a storage that stores image quality information on image quality at a predetermined timing after start of use of the image forming apparatus and before maintenance; and a hardware processor that performs image quality adjustment so as to adjust the image quality after the maintenance to the image quality stored.

### CROSS REFERENCE TO RELATED APPLICATIONS

The entire disclosure of Japanese patent Application No. 2024-083451 filed on May 22, 2024, is incorporated herein by reference in its entirety.

### BACKGROUND

### Technological Field

The present invention relates to an image processing apparatus.

### Description of Related Art

In recent years, a color printer having a color print function of copying or printing a created document as a color image has been widely used. With the spread of color printers, a color usage rate at which a document is output as a color image has increased. In such a situation, a user's demand level for image quality of a color image is increasing. Then, it is important to be able to always output a color image with similar quality.

Process characteristics of the color printer change depending on a use environment such as temperature and humidity. Therefore, a calibration function for adjusting to a target image quality is provided. Further, not only by the use environment but also by the replacement of consumables such as toner and a photosensitive member, the process characteristics are changed, thereby changing the image quality. Therefore, calibration is performed even after the replacement of the consumable to perform correction so that the original target image quality can be maintained as much as possible.

However, when the image quality is adjusted to the target image quality after the replacement of the consumable product, the image quality may become different from that before the replacement of the consumable product, which may lead to a result that is not desired by the user. This is mainly due to the difference in characteristics between the degraded consumable and the new consumable. However, it is not important for the user whether or not the image quality after replacement is the target image quality (intended by the manufacturer). For the user, it is a problem that the image quality changes from the previously used image quality. In general usage, a long-term slight change in image quality due to deterioration of consumables is not an issue, but a change in image quality in a short period is a significant issue.

For example, an image processing method described in Japanese Unexamined Patent Publication No. 2009-118349 (hereinafter, referred to as PTL 1) compares scan data of a specific image with scan data of a newly output specific image. Then, the image processing method corrects the specific image for output.

In some cases, a component is replaced as a countermeasure against a defect of a printer. In particular, a photoreceptor or a transferor is replaced due to an image-related defect. For example, when the cause of the defect is the photoreceptor, the defect is solved by replacing the photoreceptor. However, the characteristics of the printer may be changed when the photosensitive member is changed, thereby causing a change in the image quality, which is not desired by the user, at the same time.

It is difficult for the user to perform adjustment by himself/herself in order to eliminate the difference in image quality. In this case, a service person is requested to perform image quality adjustment, and image quality reproduction is adjusted on the basis of the user's memory, printed matter before component replacement, or the like. However, there is a problem in that it takes a lot of time and effort to perform adjustment work of image quality reproduction and it is difficult to sufficiently reproduce image quality that satisfies the user.

In addition, the image processing method described in the above-described PTL 1 is intended to adjust only a specific image as a target. Since this method does not correct the characteristics of the current printer, it is difficult to sufficiently reproduce an image that satisfies the user.

### SUMMARY

An object of the present invention is to provide an image processing apparatus capable of sufficiently reproducing an image satisfying a user without taking time and labor for adjustment work of image quality reproduction.

In order to achieve at least one of the above-described objects, an image processing apparatus reflecting one aspect of the present invention adjusts image quality of an image formed by an image forming apparatus, the image processing apparatus includes: a storage that stores image quality information on image quality at a predetermined timing after start of use of the image forming apparatus and before maintenance; and a hardware processor that performs image quality adjustment so as to adjust the image quality after the maintenance to the image quality stored.

### BRIEF DESCRIPTION OF DRAWINGS

The advantageous and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating an overall structure of an image forming apparatus to which an image processing apparatus according to an embodiment of the present invention is applied;

FIG. 2 is a diagram schematically illustrating an entire structure of a defect analysis system applied to an image forming apparatus according to the embodiment of the present invention;

FIG. 3 is a diagram illustrating a main part of a control system of the image forming apparatus;

FIG. 4 is a block diagram illustrating a characteristic adjuster according to the present embodiment;

FIG. 5 is a diagram illustrating an example of image quality adjustment by an image quality adjuster;

FIG. 6 is a diagram illustrating another example of image quality adjustment performed by the image quality adjuster; and

FIG. 7 is a flowchart illustrating an example of image quality adjustment processing of the characteristic adjuster.

### DETAILED DESCRIPTION OF EMBODIMENTS

Hereinafter, one or more embodiments of the present invention will be described with reference to the drawings. However, the scope of the invention is not limited to the disclosed embodiments

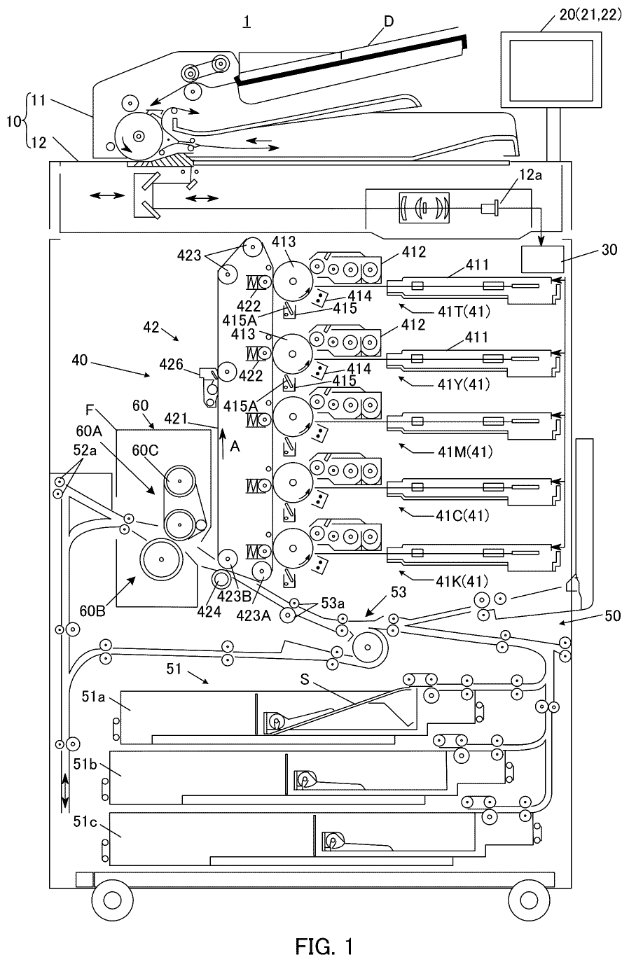

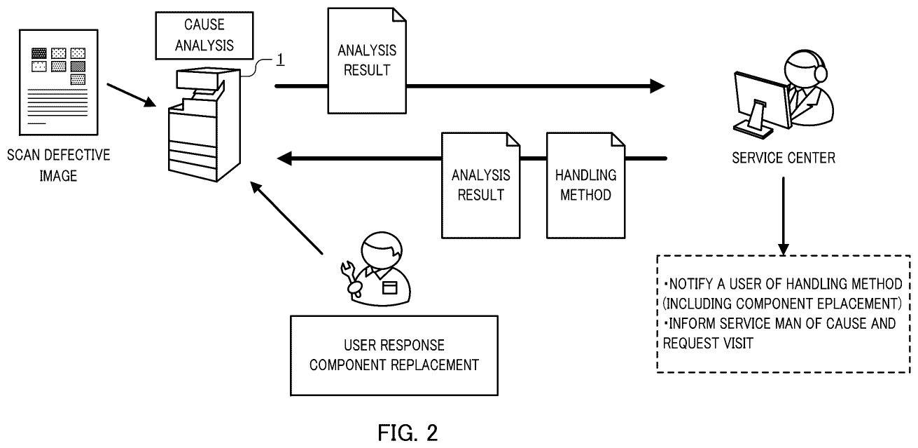

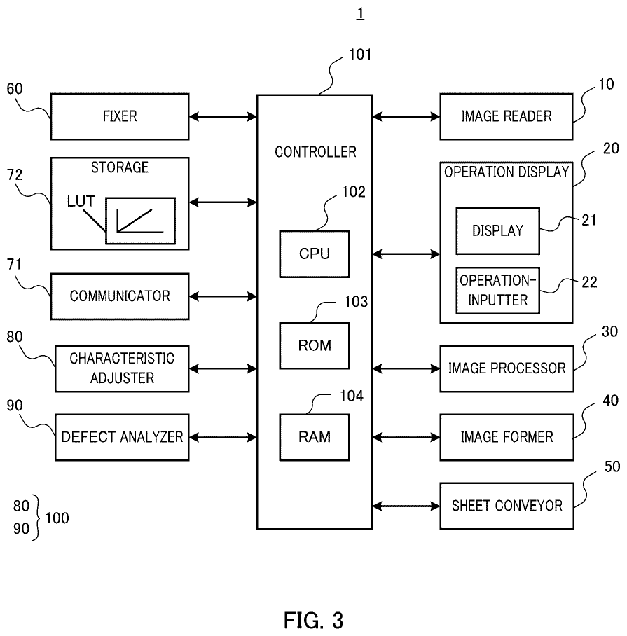

Hereinafter, an embodiment of the present invention will be described in detail with reference to the drawings. FIG. 1 is a diagram schematically illustrating an overall configuration of an image forming apparatus to which an image processing apparatus according to an embodiment is applied. FIG. 2 is a diagram schematically illustrating an overall structure of a defect analysis system applied to the image forming apparatus according to the embodiment of the present invention. FIG. 3 is a diagram illustrating a main part of a control system of an image forming apparatus 1.

The image forming apparatus 1 illustrated in FIGS. 1 and 3 is a color image forming apparatus of an intermediate transfer system using an electrophotographic process technology. That is, the image forming apparatus 1 primary transfers toner images of respective colors of yellow (Y), magenta (M), cyan (C), and black (K) formed on respective photosensitive drums 413 to an intermediate transfer belt 421. Next, the image forming apparatus 1 superimposes the toner images in four colors on the intermediate transfer belt 421, and then secondarily transfers the toner images to a sheet S, thereby forming an image.

The image forming apparatus 1 employs a tandem system. In a tandem system, the photosensitive drums 413 corresponding to four colors of YMCK are arranged in series in the traveling direction of the intermediate transfer belt 421. Next, the toner images of the respective colors are sequentially transferred to the intermediate transfer belt 421 in a single procedure.

As illustrated in FIG. 1, the image forming apparatus 1 includes an image reader 10, an operation display 20, an image processor 30, an image former 40, a sheet conveyor 50, a fixer 60, a characteristic adjuster 80 (see FIG. 3), a defect analyzer 90 (see FIG. 3), and a controller 101 (see FIG. 3).

The controller 101 includes a central processor (CPU) 102, a read only memory (ROM) 103, a random access memory (RAM) 104, and the like. The CPU 102 reads a program corresponding to the processing content from the ROM 103, develops the program in the RAM 104, and centrally controls the operation of each block of the image forming apparatus 1 in cooperation with the developed program. At this time, various kinds of data stored in a storage 72 are referred to. The storage 72 is constituted by, for example, a nonvolatile semiconductor memory (so-called flash memory) or a hard disk drive.

The controller 101 is connected to a communication network such as a local area network (LAN) and a wide area network (WAN) via a communicator 71. The communication network is connected to an external apparatus (for example, a personal computer). Thus, the controller 101 transmits and receives various kinds of data to and from an external apparatus. For example, the controller 101 receives image data transmitted from an external apparatus, and operates to form an image on the sheet S on the basis of the image data (input image data). The communicator 71 is constituted by a communication control card such as a LAN card.

As illustrated in FIG. 1, the image reader 10 includes an automatic document feeding apparatus 11 called an ADF (Auto Document Feeder), a document image scanning apparatus 12 (scanner), and the like.

The automatic document feeding apparatus 11 conveys a document D placed on a document tray by a conveyance mechanism and sends the document D to the document image scanning apparatus 12. Using the automatic document feeding apparatus 11, it is possible to continuously and collectively read images of a large number of documents D placed on the document tray (including both faces).

The document image scanning apparatus 12 optically scans a document conveyed from the automatic document feeding apparatus 11 to a contact glass or a document placed on the contact glass. Then, the document image scanning apparatus 12 forms an image of reflection light from the document on a light receiving surface of a charge-coupled apparatus (CCD) sensor 12a, and reads a document image. The image reader 10 generates input image data based on a result of reading by the document image scanning apparatus 12. The input image data undergoes predetermined image processing in the image processor 30.

As illustrated in FIG. 3, the operation display 20 is constituted by, for example, a liquid crystal display (LCD) with a touch panel. The operation display 20 functions as a display 21 and an operation-inputter 22. The display 21 displays various operation screens, the state of an image, the operation status of each function, and the like in accordance with a display control signal input from the controller 101. The operation-inputter 22 includes various operation keys such as a numeric keypad and a start key. The operation-inputter 22 receives various input operation from a user, and outputs an operation signal to the controller 101.

The image processor 30 includes a circuit and the like that apply digital image processing to input image data in accordance with initial settings or user settings. For example, the image processor 30 performs tone correction on the basis of tone correction data (tone correction table) under the control of the controller 101. The image processor 30 applies, to the input image data, not only the tone correction but also various kinds of correction processing such as color correction and shading correction, compression processing, and the like. The image former 40 is controlled on the basis of the processed image data.

As illustrated in FIG. 1, the image former 40 includes image formers 41Y, 41M, 41C and 41K, and an intermediate transferor 42. The image formers 41Y, 41M, 41C and 41K form images with color toners of Y, M, C, and K components.

The image formers 41Y, 41M, 41C and 41K for the Y component, the M component, the C component, and the K component have a similar configuration. For convenience of illustration and description, common components are denoted by the same reference signs, and when the components are distinguished from each other, Y, M, C, or K is added to the reference signs. In FIG. 1, reference signs are given only to constituent elements of the image former 41Y for the Y-component. In FIG. 1, reference signs of constituent elements of the image formers 41Y, 41C and 41K other than the image former 41M are omitted.

The image former 41 includes an exposure apparatus 411, a developing apparatus 412, a photosensitive drum 413, a charging apparatus 414, and a drum cleaning apparatus 415.

The photosensitive drum 413 is constituted by, for example, an organic photoreceptor in which a photosensitive layer constituted by resin containing an organic photoconductor is formed on an outer circumferential surface of a drum-shaped metal substrate.

The controller 101 controls a drive current supplied to a driving motor (not illustrated) that rotates the photosensitive drum 413 so as to rotate the photosensitive drum 413 at a constant peripheral speed.

The charging apparatus 414 is, for example, a scorotron, and uniformly charges the surface of the photosensitive drum 413 to a negative polarity by generating corona discharge.

Exposure apparatus 411 is constituted by, for example, a semiconductor laser, and irradiates the photosensitive drum 413 with laser light corresponding to an image of each color component. As a result, on the image area of the surface of the photosensitive drum 413 irradiated with the laser light, an electrostatic latent image of each color component is formed due to a potential difference from the background area.

The developing apparatus 412 is a developing apparatus using a two component reverse rotation method, and forms a toner image by visualizing the electrostatic latent image by causing developer of each of the color components to adhere to the surface of the photosensitive drum 413.

For example, a direct-current developing bias having the same polarity as the charging polarity of the charging apparatus 414 is applied to the developing apparatus 412. Alternatively, the developing apparatus 412 is applied with, for example, developing bias in which DC voltage having the same polarity as the charge polarity of the charging apparatus 414 is superimposed on AC voltage. As a result, inversion development, in which the toner is made to adhere to the electrostatic latent image formed by the exposure apparatus 411, is performed.

The drum cleaning apparatus 415 includes a plate-shaped drum cleaning blade 415A that is made of an elastic body and comes in contact with the photosensitive drum 413. The drum cleaning blade 415A and the like remove toner remaining on the surfaces of the photosensitive drums 413 without being transferred to the intermediate transfer belt 421.

In the exemplary embodiment, an image former 41T for white toner is provided. The image former 41T has the same configuration as the image formers 41 for the other color toners. The image former 41T is disposed at a position where the white toner can be supplied to the upper layer of the color toner. In addition, the white toner is also used when a base image is formed on the sheet S in additional printing which will be described later.

The intermediate transferor 42 includes the intermediate transfer belt 421, a primary transfer roller 422, and a plurality of support rollers 423. Intermediate transferor 42 further includes a secondary transfer roller 424, a belt cleaning apparatus 426, and the like.

The intermediate transferor 42 is formed with an endless belt and stretched in a loop around the plurality of support rollers 423. At least one of the plurality of support rollers 423 is constituted by a driving roller, and the others are constituted by driven rollers. For example, a roller 423A disposed on the downstream side of the primary transfer roller 422 for the K-component in the belt traveling direction is preferably the driving roller. Thus, the running speed of the belt at a primary transfer nip is easily kept constant. The rotation of the driving roller 423A causes the intermediate transfer belt 421 to run in an arrow direction A at a constant speed.

The intermediate transfer belt 421 is a belt having conductivity and elasticity, and is rotationally driven by a control signal from the controller 101.

The primary transfer roller 422 is arranged on an inner peripheral surface side of the intermediate transfer belt 421 in a manner facing the photosensitive drum 413 of each color component. The primary transfer roller 422 is pressed against and brought into contact with the photosensitive drum 413 with the intermediate transfer belt 421 interposed therebetween. Thus, a primary transfer nip for transferring the toner image from the photosensitive drum 413 to the intermediate transfer belt 421 is formed.

The secondary transfer roller 424 is disposed so as to face a backup roller 423B disposed on the downstream side of the driving roller 423A in the belt traveling direction. The secondary transfer roller 424 is disposed on the outer peripheral surface side of the intermediate transfer belt 421. The secondary transfer roller 424 is pressed against and brought into contact with the backup roller 423B with the intermediate transfer belt 421 interposed therebetween. Thus, a secondary transfer nip for transferring the toner image from the intermediate transfer belt 421 to the sheet S is formed.

When the intermediate transfer belt 421 passes through the primary transfer nip, the toner image on the photosensitive drum 413 is sequentially superimposed on and primarily transferred to the intermediate transfer belt 421. Specifically, a primary transfer bias is applied to the primary transfer roller 422. Next, a charge having a polarity opposite to that of the toner is applied to the back surface side of the intermediate transfer belt 421, that is, the side that comes into contact with the primary transfer roller 422. Thus, the toner images are electrostatically transferred to the intermediate transfer belt 421.

Thereafter, when the sheet S passes through the secondary transfer nip, the toner images on the intermediate transfer belt 421 are secondarily transferred to the sheet S. In particular, a secondary transfer bias is applied to the backup roller 423B to impart charge having the same polarity as the toner to the front surface side of the sheet S, that is, the side in contact with the intermediate transfer belt 421. Further, a voltage is applied to the secondary transfer roller 424 so as to have a relatively higher potential than the backup roller 423B. Thus, the toner image is electrostatically transferred to the sheet S, and the sheet S is conveyed toward the fixer 60.

The belt cleaning apparatus 426 removes transfer residual toner remaining on the surface of the intermediate transfer belt 421 after the secondary transfer. Instead of the secondary transfer roller 424, a so-called belt-type secondary transferor may be employed. The belt-type secondary transferor has, for example, a configuration in which a secondary transfer belt is stretched in a loop around a plurality of support rollers including a secondary transfer roller.

The fixer 60 includes an upper fixer 60A having a fixing surface-side member to be arranged on the fixing surface of the sheet S, that is, on the side of the surface on which the toner image is formed. Further, the fixer 60 includes a lower fixer 60B having a back surface side support member arranged on the back surface, that is, the side opposite to the fixing surface of the sheet S. The fixer 60 includes a heating source 60C and the like. The back-surface-side support member is brought into pressure contact with the fixing-surface-side member such that a fixing nip that nips and conveys sheet S is formed.

The fixer 60 heats and pressurizes the conveyed sheet S, on which the toner images have been secondarily transferred, at the fixing nip, thereby fixing the toner images on the sheet S. The fixer 60 is disposed as a unit in a fixing apparatus F.

The sheet conveyor 50 includes a sheet feeder 51, a sheet discharger 52, a conveyance path 53, and the like. The sheet feeder 51 is composed of three sheet feed trays 51a to 51c. In the three sheet feed trays 51a to 51c, the sheets S (standard sheets, special sheets) identified based on a basis weight, a size, and the like are accommodated for each type set in advance. The conveyance path 53 includes a plurality of conveyance rollers such as a registration roller pair 53a.

The sheets S accommodated in the sheet feed trays 51a to 51c are fed one by one from the top and are conveyed to the image former 40 through the conveyance path 53. At this time, a registration roller including the registration roller pair 53a corrects inclination of the fed sheet S. Further, the conveyance timing is adjusted by the registration roller. Next, in the image former 40, the toner images on the intermediate transfer belt 421 are collectively secondarily transferred to one surface side of the sheet S, and fixing processing is performed at the fixer 60. The sheet S carrying a formed image is ejected to the outside of the apparatus by a sheet ejection roller 52a.

As a countermeasure against a defect of the image forming apparatus 1, a component may be replaced. Replacement of the component may change the characteristics of the image forming apparatus 1, thereby causing a change in the image quality, which is not desired by the user, at the same time. An image processing apparatus 100 according to the present embodiment includes the characteristic adjuster 80 and the defect analyzer 90 (see FIG. 3). As a result, it is possible to sufficiently reproduce an image which satisfies the user without taking time and effort in the adjustment work of the image quality reproduction for reproducing the image quality before the component replacement. The image processing apparatus 100 includes a CPU (not illustrated), a ROM (not illustrated), and a RAM (not illustrated). The CPU reads a program according to processing contents from the ROM, develops the program in the RAM, and cooperates with the developed program to implement each function of the image processing apparatus 100.

### Characteristic Adjuster 80

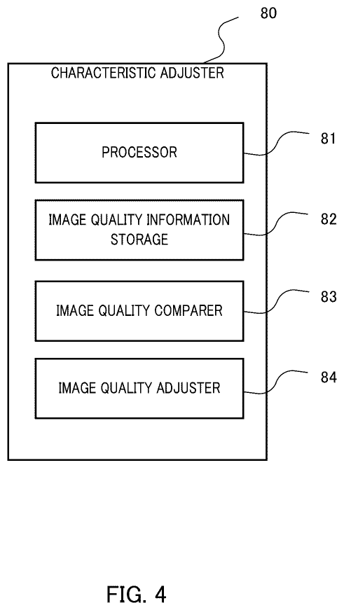

FIG. 4 is a block diagram illustrating a characteristic adjuster according to the present embodiment. As illustrated in FIG. 4, the characteristic adjuster 80 includes a processor 81, an image quality information storage 82, an image quality comparer 83, and an image quality adjuster 84.

### Processor 81

The processor 81 determines whether or not a specific event has occurred. The processor 81 stores the image quality information on the output image in the image quality information storage 82 at a predetermined timing when a specific event occurs. Here, the “output image” refers to an output image that is output as a color image through copying or printing of the document. The “predetermined timing” refers to the following case. The first case is a case in which the process is performed together with other processes. Here, the other processing is, for example, gradation correction for correcting the gradation width in order to improve the reproducibility of the output image, or a stabilization process for stabilizing the image quality of the output image. The second case is a case where the process is performed before the process in which the image quality may change is performed. Here, the time when the processing in which the image quality may change is executed is, for example, the time when component replacement or defect analysis for analyzing a defect of an output image is started. The third case is a case where the printing is forcibly performed at a predetermined time interval, or at a fixed time interval such as turning on/off of the power, or, for a predetermined number of printed sheets. The “image quality information” is, for example, image quality information extracted from the detection result of the toner pattern on the transfer belt at the time of stabilization. Further, the “image quality information” is, for example, image quality information extracted from a test pattern reading result at the time of gradation correction or defect analysis.

The processor 81 continues to store the image quality information in the image quality information storage 82 until maintenance such as replacement of consumables due to the end of their service life or countermeasures against defects is executed. Further, the processor 81 stores the image quality information in the image quality information storage 82 at a predetermined timing. Here, the “maintenance” includes adjustment of engine characteristics in the image forming apparatus 1 and adjustment of characteristics by image processing. The image quality information stored in the image quality information storage 82 before the execution of the maintenance is referred to as “image quality information before maintenance”.

The processor 81 determines whether or not maintenance has been executed. In a case where maintenance has been executed, the processor 81 determines whether or not the maintenance is intended to resolve image defects. When the processor determines that the maintenance is intended to resolve image defects, the defect analyzer 90 analyzes image defects. Here, the term “image defects” refers to stains such as spots in an image, vertical lines of black or gray, thin printing, blurred image, color unevenness, color misregistration, and the like.

### Defect Analyzer 90

As illustrated in FIG. 3, the function of analyzing image defects of the defect analyzer 90 exists inside the image forming apparatus 1. For example, when a defect occurs, a defect image is scanned, and the defect analyzer 90 performs defect analysis. As illustrated in FIG. 2, the service center presents the user with a handling method including component replacement. Alternatively, the service center informs a service person of the cause of the defect and requests the service person to visit the user. Alternatively, the setting change or the parameter adjustment of the target image forming apparatus 1 is performed remotely. The image output after the handling is scanned to confirm the improvement of the defect, and when the defect is improved, the handling work is finished. Note that the function of the defect analyzer 90 may be provided in an external server connected to the image forming apparatus 1 via a communication network.

A defect analyzer 90 analyzes the image defects on the basis of image quality information before maintenance. Further, the defect analyzer 90 analyzes image defects with reference to the operation data of the image forming apparatus 1 and the maintenance/inspection history data of the image forming apparatus 1. The processor 81 stores a defect analysis result analyzed by the defect analyzer 90 in the image quality information storage 82.

In a case where maintenance has been executed, the processor 81 stores the image quality information in the image quality information storage 82 in parallel with the execution of maintenance. Further, the processor 81 stores the image quality information in the image quality information storage 82 regardless of whether the maintenance is intended to eliminate image defects. The image quality information stored in the image quality information storage 82 in parallel with the execution of maintenance is referred to as “image quality information after maintenance”.

The image quality comparer 83 performs image quality comparison between the image quality information before maintenance and the image quality information after maintenance, and extracts their differences. Note that the image quality comparer 83 refers to the defect analysis result read from the image quality information storage 82 when performing the image quality comparison and the difference extraction. Thus, the accuracy of the difference extraction by the image quality comparer 83 can be improved.

### Image Quality Adjuster 84

The image quality adjuster 84 executes image quality adjustment such that that the image quality after the maintenance becomes the same as the image quality before the maintenance on the basis of the image quality comparison result. Here, the “image quality adjustment” includes engine characteristics used when an image is formed by the image forming apparatus 1. The engine characteristics include, for example, control parameter values of the image forming apparatus 1. Further, the “image quality adjustment” includes characteristics that are used when image forming apparatus 1 performs image processing. The characteristics include, for example, a gamma value (gamma table value) of an image, a width of a character or a line, and a color conversion parameter.

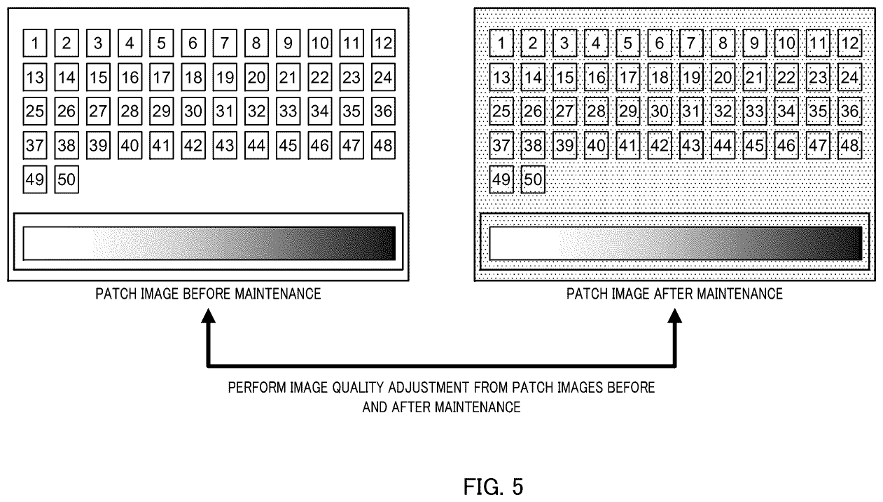

Next, an example of image quality adjustment performed by the image quality adjuster 84 will be described with reference to FIG. 5. FIG. 5 is a diagram illustrating patch images before and after maintenance. The left side of FIG. 5 illustrates a plurality of color patches in a patch image before maintenance. The right side of FIG. 5 illustrates a plurality of color patches in the patch image after maintenance. Note that each of the plurality of color patches drawn in the patch image illustrated in FIG. 5 is denoted with a number. The image quality adjuster 84 executes the image quality adjustment such that the image quality of the patch image before maintenance and the image quality of the patch image after maintenance become the same. The image quality adjustment result is stored in the image quality information storage 82.

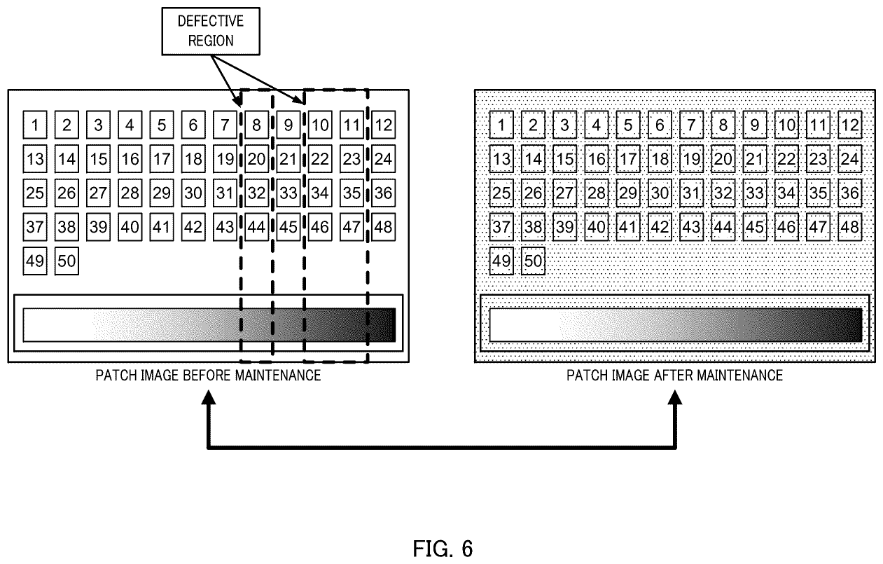

Next, another example of image quality adjustment by the image quality adjuster 84 will be described with reference to FIG. 6. FIG. 6 is a diagram illustrating patch images before and after maintenance. The left side of FIG. 6 illustrates a plurality of color patches in a patch image before maintenance. The right side of FIG. 6 illustrates a plurality of color patches in the patch image after maintenance. Note that each of the plurality of color patches drawn in the patch image illustrated in FIG. 6 is denoted with a number. Some of the plurality of color patches drawn in the patch image may be a defect. A defective region in the patch image before maintenance illustrated on the left side of FIG. 6 is indicated by a number (defect number) arranged in a region surrounded by a broken line. The image quality adjuster 84 executes image quality adjustment by excluding a defective region. The defect numbers are “8”, “10”, “11”, “20”, “22”, “23”, “32”, “34”, “35”, “44”, “46”, and “47”. The image quality adjustment result is stored in the image quality information storage 82.

The image quality before maintenance in a state where the image forming apparatus 1 is used for a long period of time may be changed from the image quality of the initial state intended by the manufacturer. Basically, by reproducing the image quality before the maintenance, the user can use the image forming apparatus 1 with the same image quality as before. However, when the image quality of the initial state is compared with the image quality before maintenance upon reevaluation, it may be determined that the image quality in the initial state is more preferable. Therefore, the image quality adjustment result is stored in the image quality information storage 82 separately from the initial adjustment result. Storing the adjustment results of both the image quality recommended by the manufacturer and the image quality before maintenance makes it possible to change the image quality in accordance with the user's preference.

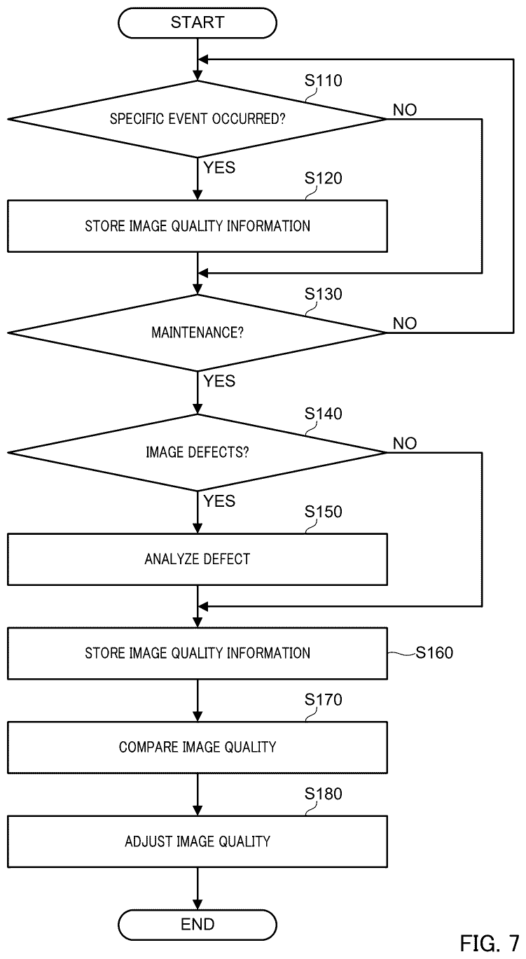

Next, image quality adjustment processing in the characteristic adjuster 80 will be described with reference to FIG. 7. FIG. 7 is a flowchart illustrating an example of image quality adjustment processing in the characteristic adjuster 80. This flow is started in response to activation of the image forming apparatus 1.

First, in step S110, the processor 81 determines whether or not a specific event has occurred. In a case where a specific event has occurred (step S110: YES), the process transitions to step S120. In a case where a specific event has not occurred (step S110: NO), the process transitions to step S130.

Next, in step S120, the processor 81 stores the image quality information on the output image in the image quality information storage 82.

Next, in step S130, the processor 81 determines whether or not maintenance has been executed. In a case where maintenance has been executed (step S130: YES), the process proceeds to step S140. In a case where maintenance has not been executed (step S130: NO), the process returns to before step S110.

Next, in step S140, the processor 81 determines whether or not the maintenance is intended to resolve image defects. In a case where the maintenance is intended to resolve image defects (step S140: YES), the process transitions to step S150. In a case where the maintenance is not intended to resolve image defects (step S140: NO), the process transitions to step S160.

Next, in step S150, the defect analyzer 90 executes defect analysis.

Next, in step S160, the processor 81 stores the image quality information in the image quality information storage 82.

Next, in step S170, the image quality comparer 83 compares the image quality information before maintenance and the image quality information after maintenance, and extracts their differences.

Next, in step S180, the image quality adjuster 84 executes image quality adjustment on the basis of the comparison result of the image quality comparer 83. The image quality adjuster 84 executes image quality adjustment such that that the image quality after the maintenance becomes the same as the image quality before the maintenance. Thereafter, the present flow ends.

The image processing apparatus 100 according to the above-described embodiment is an image processing apparatus capable of adjusting the image quality of an image formed by the image forming apparatus 1. The image processing apparatus 100 includes the image quality information storage 82 that stores image quality information at a predetermined timing after the start of use of the image forming apparatus 1 and before maintenance. Further, the image processing apparatus 100 includes the image quality adjuster 84 that performs image quality adjustment so as to match the image quality after maintenance with the stored image quality.

With the above-described configuration, the image quality before maintenance stored at the predetermined timing in the image quality information storage 82 and the image quality after maintenance are matched. As a result, it is possible to sufficiently reproduce an image satisfying a user without taking time and labor for adjustment work of image quality reproduction.

Further, in the image processing apparatus 100 according to the above-described embodiment, the predetermined timing is a timing at which the stabilization process is executed on the image forming apparatus 1. Thus, even when the stabilization process is executed during the maintenance, the image quality information before the maintenance can be stored in the image quality information storage 82.

Further, in the image processing apparatus 100 according to the above-described embodiment, the predetermined timing is timing at which tone correction of an image is executed on the image forming apparatus 1. Thus, even when the gradation correction is executed during the maintenance, the image quality information before the maintenance can be stored in the image quality information storage 82.

In addition, in the image processing apparatus 100 according to the above-described embodiment, the predetermined timing is a timing at which analysis of image defects in the image forming apparatus 1 is started. Thus, even when the analysis of image defects is started during the maintenance, the image quality information before the maintenance can be stored in the image quality information storage 82.

Further, in the image processing apparatus 100 according to the above-described embodiment, the predetermined timing is a timing at which processing associated with replacement of a component of the image forming apparatus 1 is started. Thus, even when processing involving component replacement is started during maintenance, the image quality information before the maintenance can be stored in the image quality information storage 82.

Further, in the image processing apparatus 100 according to the above-described embodiment, the predetermined timing is a timing at predetermined fixed intervals. Thus, the image quality information is stored in the image quality information storage 82 at a fixed interval regardless of whether maintenance is performed or not. As a result, the image quality information before the maintenance can be stored in the image quality information storage 82.

Further, in the image processing apparatus 100 according to the above-described embodiment, the image quality adjuster 84 performs an image quality adjustment during the stabilization process. Thus, even when image quality adjustment has been performed along with the stabilization process, the image quality adjuster 84 can adjust the image quality after maintenance to the image quality before maintenance. As a result, it is possible to sufficiently reproduce an image satisfying the user.

Further, in the image processing apparatus 100 according to the above-described embodiment, the image quality adjuster 84 performs an image quality adjustment along with the tone correction. Thus, even in a case where the image quality adjustment is performed along with the tone correction, the image quality after the maintenance is adjusted to the image quality before the maintenance by the image quality adjuster 84. As a result, it is possible to sufficiently reproduce an image satisfying the user.

Further, in the image processing apparatus 100 according to the above-described embodiment, the image quality adjuster 84 performs image quality adjustment in accordance with processing for improving a problem. Thus, even in a case where the image quality adjustment is performed along with the defect improvement processing, the image quality after the maintenance is adjusted to the image quality before the maintenance by the image quality adjuster 84. As a result, it is possible to sufficiently reproduce an image satisfying the user.

Further, in the image processing apparatus 100 according to the above-described embodiment, the image quality adjuster 84 performs the image quality adjustment such that regions other than the defective region in the entire image match. Thus, the image quality after the maintenance does not match the image quality of the defective region before the maintenance. As a result, an image satisfying the user can be reproduced. In addition, it is possible to exclude a process in which the image quality after maintenance is matched with the image quality of the defective region before maintenance. As a result, it is possible to avoid waste of image quality adjustment work.

Further, in the image processing apparatus 100 according to the above-described embodiment, the image quality adjuster 84 adjusts the engine characteristics that are used when an image is formed by the image forming apparatus. Image quality adjustment is performed by adjusting engine characteristics. As a result, by adjusting the engine characteristics, it is possible to adjust the image quality such that the image quality after maintenance matches the image quality before maintenance.

Further, in the image processing apparatus 100 according to the above-described embodiment, the image forming apparatus 1 performs image processing on the basis of the characteristic. The image quality adjuster 84 performs image quality adjustment by adjusting characteristics. Thus, by adjusting the characteristics in the image processing, it is possible to adjust the image quality such that the image quality after the maintenance matches the image quality before the maintenance.

Note that in the image processing apparatus 100 according to the above-described embodiment, the initial adjustment results and the image quality adjustment results are stored separately in the image quality information storage 82. In this manner, by resetting the adjustment value to the initial value after the replacement of the consumables, it is possible to maintain substantially the same image quality as before the replacement of the consumables. Note that the image quality adjustment includes both characteristics (items) adjusted to maintain quality and characteristics (items) adjusted to the user's preference. In this case, for example, only the characteristic (item) adjusted for maintaining the quality may be returned to the initial value at the time of replacing the consumable.

In addition, each of the above-described embodiments is merely an example for embodying the present invention, and the technical scope of the present invention should not be interpreted in a limited manner by these embodiments. That is, the present invention can be implemented in various forms without departing from the spirit or main features thereof.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image processing apparatus that adjusts image quality of an image formed by an image forming apparatus, the image processing apparatus comprising:
a storage that stores image quality information on image quality at a predetermined timing after start of use of the image forming apparatus and before maintenance; and
a hardware processor that performs image quality adjustment so as to adjust the image quality after the maintenance to the image quality stored.

2. The image processing apparatus according to claim 1, wherein the predetermined timing is a timing at which a stabilization process is executed on the image forming apparatus.

3. The image processing apparatus according to claim 1, wherein the predetermined timing is a timing at which tone correction of an image is executed on the image forming apparatus.

4. The image processing apparatus according to claim 1, wherein the predetermined timing is a timing at which analysis of image defects in the image forming apparatus is started.

5. The image processing apparatus according to claim 1, wherein the predetermined timing is a timing at which a process associated with replacement of a component constituting the image forming apparatus is started.

6. The image processing apparatus according to claim 1, wherein the predetermined timing is a timing at a predetermined constant interval.

7. The image processing apparatus according to claim 2, wherein the hardware processor performs the image quality adjustment along with the stabilization process.

8. The image processing apparatus according to claim 3, wherein the hardware processor performs the image quality adjustment along with the tone correction.

9. The image processing apparatus according to claim 4, wherein the hardware processor performs the image quality adjustment along with a process for correcting the defect.

10. The image processing apparatus according to claim 9, wherein the hardware processor performs the image quality adjustment such that regions other than a defective region in the entire image match.

11. The image processing apparatus according to claim 1, wherein the hardware processor performs the image quality adjustment by adjusting an engine characteristic that is used when an image is formed by the image forming apparatus.

12. The image processing apparatus according to claim 1,
wherein the image forming apparatus performs image processing based on a characteristic, and
wherein the hardware processor performs the image quality adjustment by adjusting the characteristic.
